(19) United States
(12) Patent Application Publication
(10) Pub. No.: US 2021/0243228 A1
(43) Pub. Date: Aug. 5, 2021

(54) METHOD AND APPARATUS FOR MANAGING A PLURALITY OF USER TERMINALS USING CHANGEABLE IDENTIFICATION VALUES OF THE USER TERMINAL

(71) Applicant: Softlunch Inc., Seoul (KR)

(72) Inventor: Jin Heung BAE, Seoul (KR)

(73) Assignee: Softlunch Inc., Seoul (KR)

(21) Appl. No.: 17/165,287

(22) Filed: Feb. 2, 2021

(30) Foreign Application Priority Data
Feb. 3, 2020 (KR) 10-2020-0012627

(51) Int. Cl. H04L 29/06; H04W 8/00; H04W 8/18

(52) U.S. Cl. CPC H04L 63/20; H04W 8/183; H04W 8/005

(57) ABSTRACT

Provided are a method and apparatus for managing a terminal. The method of managing a terminal may include obtaining a variable identification value of a first user terminal, generating a first user terminal group including the first user terminal based on an identification value of a first user, and mapping variable identification values of one or more user terminals included in the first user terminal group to the identification value of the first user and mapping user information obtained from an external device to the identification value of the first user.

### CROSS-REFERENCE TO RELATED APPLICATION

This application is based on and claims priority under 35 U.S.C. § 119 to Korean Patent Application No. 10-2020-0012627, filed on Feb. 3, 2020, in the Korean Intellectual Property Office, the disclosure of which is incorporated by reference herein in its entirety.

### BACKGROUND

### 1. Field

The disclosure relates to a method and apparatus for managing a user terminal. More particularly, the disclosure relates to a method and apparatus for managing a plurality of user terminals using variable identification values of the user terminals.

### 2. Description of Related Art

When a user terminal is managed by using a user's personal information stored in the user terminal, there is a disadvantage of poor security due to the possibility of information leakage. Accordingly, methods of managing a plurality of user terminals through connection with an external account using fixed identification values of the user terminals have been actively developed. However, when the user terminals are managed by using fixed unique identification values of the user terminals, there is a limitation in that continuous management of the user terminals is impossible due to device changes of the user terminals. Therefore, there is a need to provide a technology capable of continuously managing a plurality of user terminals while ensuring security.

### SUMMARY

Embodiments of the disclosure provide a method and apparatus for managing a user terminal without using a fixed identification number of the user terminal and user personal information.

Additional aspects will be set forth in part in the description which follows and, in part, will be apparent from the description, or may be learned by practice of the presented embodiments of the disclosure

According to an embodiment of the disclosure, a method of managing a terminal includes obtaining a variable identification value of a first user terminal, generating a first user terminal group including the first user terminal based on an identification value of a first user, and mapping variable identification values of one or more user terminals included in the first user terminal group to the identification value of the first user and mapping user information obtained from an external device to the identification value of the first user.

According to an embodiment, the method may further include transmitting designated content to the one or more user terminals included in the first user terminal group, wherein the designated content may be determined based on the identification value of the first user.

According to an embodiment, the method may further include obtaining a variable identification value of a second user terminal, generating a second user terminal group including the second user terminal based on an identification value of a second user, and when the identification value of the first user and the identification value of the second user satisfy a preset condition, further transmitting content determined based on the identification value of the first user to one or more user terminals included in the second user terminal group.

According to an embodiment, the variable identification value of the first user terminal may be a unique value of the first user terminal that is changeable by a user, log data of a first application executed in the first user terminal may correspond to the variable identification value of the first user terminal, and the designated content may be executed in at least one of the first application and a second application of the first user terminal.

According to an embodiment, the first user terminal group may further include a third user terminal, and the designated content transmitted to the third user terminal may be determined based on log data of a first application executed in the first user terminal.

According to another embodiment of the disclosure, an apparatus for managing a terminal includes a processor, wherein the processor is configured to obtain a variable identification value of a first user terminal, generate a first user terminal group including the first user terminal based on an identification value of a first user, map variable identification values of one or more user terminals included in the first user terminal group to the identification value of the first user, map user account information obtained from an external device to the identification value of the first user, and transmit designated content to the one or more user terminals included in the first user terminal group, wherein the designated content is determined based on the identification value of the first user.

Other features and advantages of the disclosure will become more apparent from the drawings, the claims, and the detailed description.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a diagram of a terminal management system for performing a terminal management method, according to an embodiment of the disclosure;

FIGS. 2 and 3 are diagrams for describing a configuration and operation of a terminal management apparatus, according to an embodiment of the disclosure;

FIGS. 4 and 5 are flowcharts of a terminal management method, according to an embodiment of the disclosure;

FIGS. 6 and 7 illustrate examples of a database model used in a terminal management method, according to an embodiment of the disclosure; and

FIG. 8 is a diagram for describing a method of providing designated content to a terminal in a terminal management method, according to an embodiment of the disclosure.

### DETAILED DESCRIPTION

The following detailed description refers to the accompanying drawings which illustrate specific embodiments by which the disclosure may be implemented. These embodiments are described as detailed as possible to enable those of ordinary skill in the art to implement the disclosure. It should be understood that various embodiments of the disclosure are different from each other but need not be mutually exclusive. For example, specific shapes, structures, and characteristics described herein may be changed from one embodiment to another and implemented without departing from the spirit and scope of the disclosure. Also, it should be understood that the positions or arrangements of individual components in each embodiment may be changed without departing from the sprit and scope of the disclosure. Therefore, it should be considered that the following detailed description is not for purposes of limitation and the scope of the disclosure encompasses the scope of claims and all scopes equivalent thereto. Like reference numerals in the drawings denote the same or similar components over several aspects.

Hereinafter, various embodiments of the disclosure will be described in detail with reference to the accompanying drawings in order to enable those of ordinary skill in the art to easily implement the disclosure.

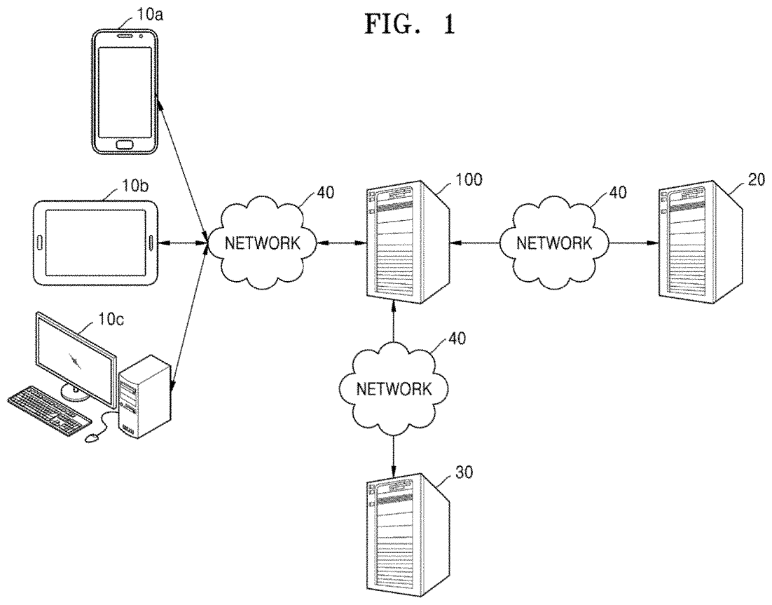

Hereinafter, a terminal management system including a terminal management method, according to an embodiment of the disclosure, will be described in detail with reference to FIG. 1.

According to an embodiment, the terminal management system may include one or more user terminals 10a, 10b, and 10c, a terminal management apparatus 100, and an external device 20. In some embodiments, the terminal management system may further include a content providing device 30.

In an embodiment, communication may be performed between the one or more user terminals 10a, 10b, and 10c and the terminal management apparatus 100, between the terminal management apparatus 100 and the external device 20, and between the terminal management apparatus 100 and the content providing device 30, by using a network 40. The network communication method is not limited thereto. In an embodiment, communication between the one or more user terminals 10a, 10b, and 10c and the external device 20 and communication between the one or more user terminals 10a, 10b, and 10c and the content providing device 30 may be performed by using the network 40.

Hereinafter, the types of user terminals 10a, 10b, and 10c used to describe the embodiments of the disclosure are not limited. The user terminals may include, for example, one of a mobile communication terminal, a tablet PC, and a desktop, various types of wearable devices such as smartwatches, or any one of Internet of Things (IoT) devices. With the development of IT technology, the number of users using one or more user terminals is increasing, and accordingly, development for a technology capable of systematic management of a plurality of user terminals has been actively conducted. The user terminals 10a, 10b, and 10c are usually assigned device-specific values, and the device-specific values are for device identification, and thus are not changed even though factory reset is performed. Accordingly, many service providers use the international mobile equipment identity (IMEI), which is an example of the device-specific values, in order to identify users. However, because the IMEI is part of personal information, when the IMEI is leaked to the outside, the damage may be tremendous.

Therefore, according to an embodiment of the disclosure, the terminal management apparatus 100 may manage the one or more user terminals 10a, 10b, and 10c by using variable identification values of the user terminals. The variable identification values of the user terminals are each a unique identification value of the corresponding user terminal different from other devices, but may be changed and reset by a user. For example, in the case of smartphones, an advertisement identifier (ADID) may be used as a variable identification value of a user terminal. However, it should be noted that this is only an example for understanding of the variable identification value of the user terminal, and the variable identification value of the user terminal used in some embodiments of the disclosure is not limited to the ADID.

In an embodiment, the terminal management apparatus 100 may obtain a variable identification value of each of the one or more user terminals 10a, 10b, and 10c. Also, the terminal management apparatus 100 may generate a user terminal group including one or more user terminals by using the obtained variable identification values of the user terminals. In an embodiment, the user terminal group may be composed of terminals of the same user. Accordingly, the terminal management apparatus 100 may map variable identification values of one or more user terminals included in a single user terminal group to a user identification value and may map user account information obtained from the external device to the user identification value. In an embodiment, the user terminal group may include terminals of a plurality of users. In this case, the terminal management apparatus 100 may map variable identification values of the user terminals included in the user terminal group to identification values of a plurality of users or may generate a user group and map identification values of the corresponding user group to the variable identification values of the user terminals. In an embodiment, the terminal management apparatus 100 may separately generate an identification value for the user terminal group and map the identification value of the user terminal group to a user identification value and/or an identification value of a user group.

In an embodiment, the user identification value may include unique data for each user. For example, the user identification value may be a user identification (ID) determined by the user or may be unique identification data of the user arbitrarily assigned by the terminal management apparatus 100.

In an embodiment, user information may be stored in the external device 20. As an example, the external device 20 may include a third party in which user account information is stored. According to some embodiments of the disclosure, the terminal management apparatus 100 may not obtain and/or store personal information about the user as well as a fixed device-specific value of the user terminal to increase security. Accordingly, according to an embodiment, the terminal management apparatus 100 may identify the user by mapping the user account information obtained from the external device 20 to the user identification value.

In an embodiment, the terminal management apparatus 100 may transmit content to the one or more user terminals 10a, 10b, and 10c by using the terminal management method. In this case, the terminal management apparatus 100 may transmit content received from a separate content providing device 30 to the one or more user terminals 10a, 10b, and 10c, or the content providing device 30 may directly transmit content to the one or more user terminals 10a, 10b, and 10c. In addition, the content providing device 30 may be included in the terminal management apparatus 100. In this case, the content providing device 30 and the terminal management apparatus 100 may be modules operating in one hardware, which are not physically separated from each other.

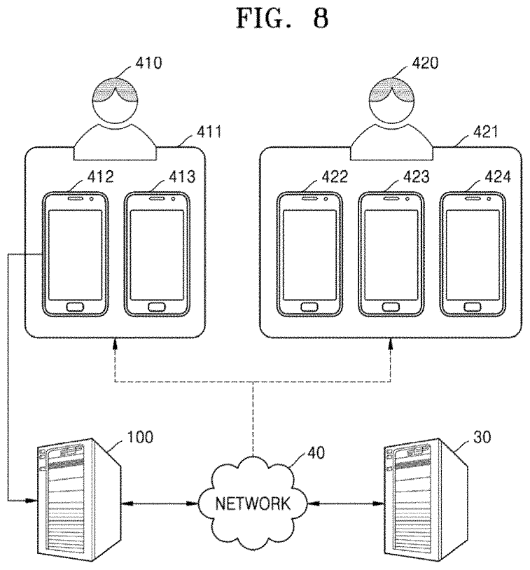

In an embodiment, the terminal management apparatus 100 may transmit the same content to one or more user terminals 10a, 10b, and 10c included in the same user terminal group. In this case, the content may be determined based on the user identification value. For example, a first user terminal and a second user terminal mapped to the same user identification value may be included in the same user terminal group. In this regard, the terminal management apparatus 100 may transmit content to the second user terminal based on information about the first user terminal or may transmit content designated based on information about a first application executed in the first user terminal to a second application executed in the first user terminal. Also, In an embodiment, the terminal management apparatus 100 may transmit, based on whether a first user and a second user satisfy a preset condition, content designated based on an identification value of the first user to a user terminal of the second user. As an example, the content transmitted to the user terminals 10a, 10b, and 10c may include advertisement content. In this case, the terminal management apparatus 100 may designate and transmit advertisement content by using information about the corresponding user terminal and one or more of information about another user terminal, information about a user terminal used in the past, and information about a user terminal of another user. A more detailed description thereof will be provided below with reference to FIG. 8.

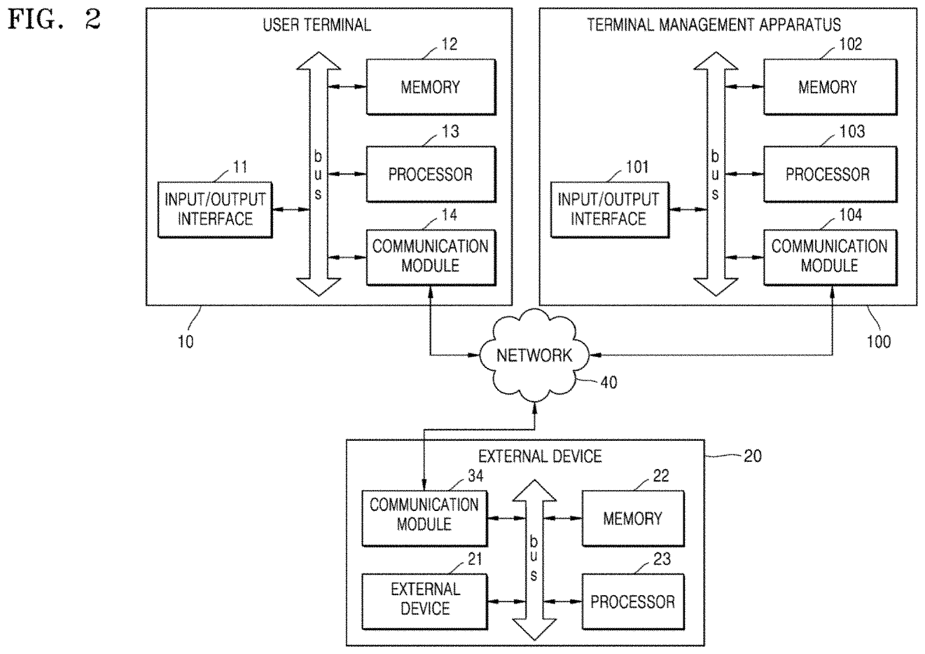

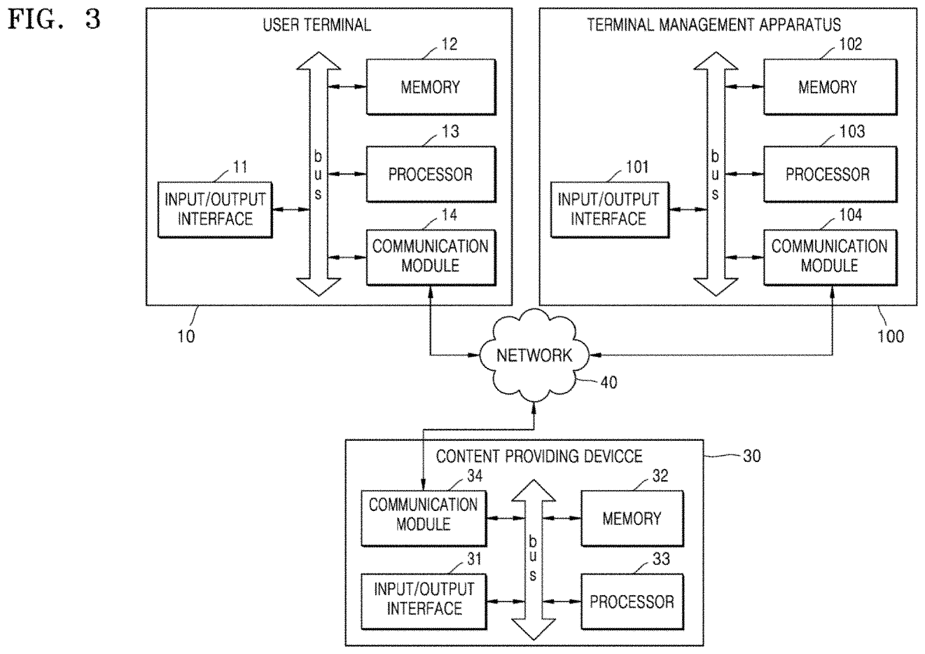

Hereinafter, a configuration and an operation of the terminal management apparatus will be described in detail with reference to FIGS. 2 and 3.

In FIG. 2, internal configurations of a user terminal 10, a terminal management apparatus 100, and an external device 20, according to an embodiment of the disclosure, will be described in detail.

In an embodiment, the user terminal 10, the terminal management apparatus 100, and the external device 20 may include input/output interfaces 11, 21, and 101, memories 12, 22, and 102, processors 13, 23, and 103, and communication modules 14, 24, and 104. The memories 12, 22, and 102 are computer-readable recording media and may include random access memory (RAM), read only memory (ROM), and permanent mass storage devices such as disk drives. Also, the memories 12, 22, and 102 may temporarily or permanently store program codes and settings for controlling the user terminal 10, the terminal management apparatus 100, or the external device 20, camera images, and pose data of objects.

The processors 13, 23, and 103 may be configured to process instructions of computer programs by performing basic arithmetic, logic, and input/output operations. The instructions may be provided to the processors 13, 23, and 103 by the memories 12, 22, and 102 or the communication modules 14, 24, and 104. For example, the processors 13, 23, and 103 may be configured to execute instructions received according to program codes stored in recording devices such as the memories 12, 22, and 102. In an embodiment, the processor 103 of the terminal management apparatus 100 may generate a user terminal group including the corresponding user terminal 10 based on a variable identification value of the user terminal 10 obtained by using the communication module 104. The processor 103 may map variable identification values of one or more user terminals included in the user terminal group to the user identification value and map user account information received from the external device 20 through the communication module 104 to the user identification value. Also, in an embodiment, the processor 103 may transmit designated content to the one or more user terminals included in the user terminal group, obtain a variable identification value of a new user terminal different from the user terminals, and generate a new user terminal group including the new user terminal based on a user identification value different from the user. Thereafter, when a preset condition is satisfied between a plurality of users or between a plurality of user identifiers, the processor 103 may also transmit content determined based on a previous user identification value, to one or more user terminals included in the new user terminal group.

The communication modules 14, 24, and 104 may provide a function for communication through the network 40. As an example, a request generated by the processor 13 of the user terminal 10 according to a program code stored in a recording device such as the memory 12 may be transmitted to the terminal management apparatus 100 through the network 40 under the control of the communication module 14. In contrast, control signals, instructions, content, files, etc. provided under the control of the processor 103 of the terminal management apparatus 100 may be received by the user terminal 10 through the communication module 14 via the network 40. For example, control signals or instructions of the terminal management apparatus 100 received through the communication modules 14, 24, and 104 may be transmitted to the processors 13, 23, and 103 or the memories 12, 22, and 102, and content or files may be stored in a recording medium that the user terminal 10 may further include. In an embodiment, a variable identification value of the user terminal 10 may be transmitted to the communication module 104 of the terminal management apparatus 100 via the network 40 by using the communication module 14 of the user terminal 10. Also, in an embodiment, user account information stored in the external device 20 may be transmitted to the communication module 104 of the terminal management apparatus 100 via the network 40 by using the communication module 24 of the external device 20.

In addition, the communication module 14 may communicate with the external device 20 through the network 40. The communication method is not limited, and the network 40 may include a local area wireless communication network. For example, the network 40 may include Bluetooth, Bluetooth Low Energy (BLE), or a Wi-Fi communication network.

The input/output interfaces 11, 21, and 101 may receive a user input and display output data. As an example, an identification value of the user terminal 10 may be changed in response to a user input that is input through the input/output interface 11 of the user terminal 10.

Also, in other embodiments, the user terminal 10, the terminal management apparatus 100, and the external device 20 may include more components than those of FIG. 2. However, there is no need to clearly illustrate most of the components of the related art. For example, the user terminal 10 may include a battery and a charging device for supplying power to internal components of a user terminal, may be implemented to include at least some of the input/output devices, or may further include different components such as a transceiver, a global positioning system (GPS) module, various sensors, a database, etc.

Also, in an embodiment, the terminal management apparatus 100 and the external device 20 may not be physically separated from each other. In this case, the terminal management apparatus 100 and the external device 20 may exist in the form of modules included in single hardware.

In FIG. 3, internal configurations of the user terminal 10, the terminal management apparatus 100, and the content providing device 30, according to an embodiment of the disclosure, will be described in detail.

Hereinafter, the same or similar description as in FIG. 2 will be omitted to avoid repeated descriptions. For example, hardware configurations of the user terminal 10 and the terminal management apparatus 100 illustrated in FIG. 3 may be similar.

In an embodiment, the content providing device 30 may include an input/output interface 31, a memory 32, a processor 33, and a communication module 34.

The content providing device 30 may communicate with the network 40, the terminal management apparatus 100, and/or the user terminal 10 by using the communication module 34. Also, In an embodiment, the content providing device 30 and the terminal management apparatus 100 may be separate modules included in single hardware, which are not physically separated from each other.

In an embodiment, the processor 33 of the content providing device 30 may transmit content, which has been transmitted to the user terminal 10 based on a user identification value obtained by the terminal management apparatus 100, to the terminal management apparatus 100 and/or the user terminal 10. For example, the processor 33 of the content providing device 30 may transmit, based on a user identification value, designated content to the user terminal 10 corresponding to the same user identification value. For example, when the content transmitted by the content providing device 30 is advertisement content, the content providing device 30 may designate advertisement content optimized for the user terminal 10 based on a user identification value received from the terminal management apparatus 100.

In an embodiment, the processor 33 of the content providing device 30 may transmit content requested from the terminal management apparatus 100 to the user terminal 10 and/or the terminal management apparatus 100. In this case, the processor 103 of the terminal management apparatus 100 may designate content to be transmitted to the user terminal 10, and the content providing device 30 may transmit content corresponding to the request of the terminal management apparatus 100 through the network 40. For example, when the content transmitted by the content providing device 30 is advertisement content, the terminal management apparatus 100 may designate advertisement content optimized for each user terminal 10. A more detailed description thereof will be provided with reference to FIG. 8.

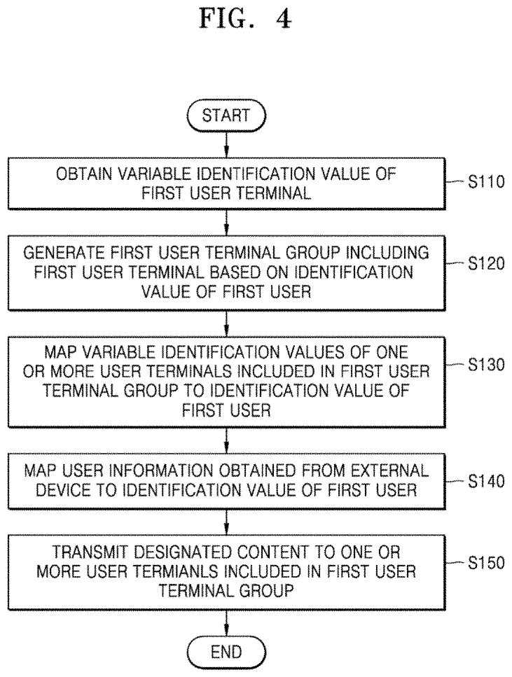

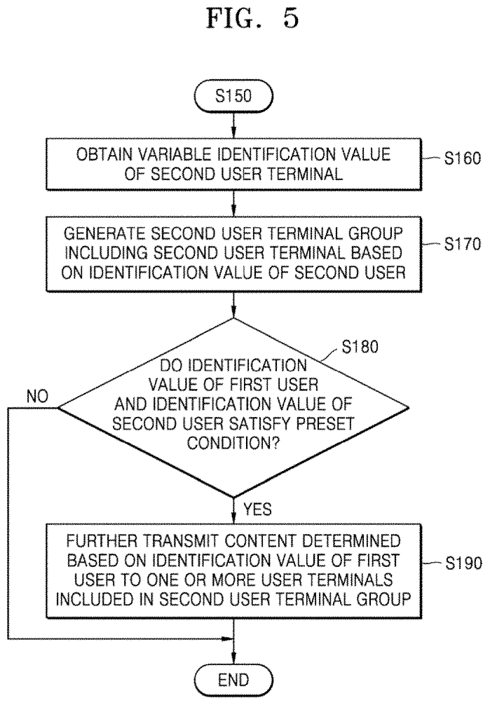

FIGS. 4 and 5 are flowcharts of a terminal management method, according to an embodiment of the disclosure.

Hereinafter, the terminal management method according to an embodiment of the disclosure will be described in detail with reference to FIG. 4. The order of the terminal management method according to some embodiments of the disclosure is not limited to the flowchart illustrated in FIG. 4, and some operations that may be performed by those of ordinary skill in the art may also be omitted or changed.

In operation S110, a variable identification value of a first user terminal may be obtained. In an embodiment, a variable identification value of a user terminal may be a unique value of the user terminal that is changeable by a user. Accordingly, log data of an application executed in the first user terminal and user information may correspond to the identification value of the first user terminal. For example, when the user terminal is a smartphone, an ADID may be used as the variable identification value of the user terminal. That is, in this case, the terminal management apparatus may identify the corresponding user terminal by using a Google Advertising ID (GAID) or an Identifier for Advertisers (IDFA) assigned to each operating system of the smartphone. However, it should be noted that the ADID is only an example for understanding of the variable identification value of the user terminal, and the variable identification value of the user terminal used in some embodiments of the disclosure is not limited to the ADID.

In operation S120, a first user terminal group including a first user terminal may be generated based on an identification value of a first user. In an embodiment, the first user terminal group may correspond one-to-one to the identification value of the first user. In this case, one or more user terminals included in one user terminal group may be user terminals of the same user. However, according to some embodiments of the disclosure, the user terminal group is not limited thereto and may include terminals of a plurality of users satisfying a preset condition.

When the user terminal group including the terminals of the users is generated, in an embodiment, a specific user may know information about a user terminal group to which his or her user terminal belongs and may register his or her user terminal in a desired user terminal group. For example, in the case of a plurality of users having a specific relationship such as a family or friends, the users may register their user terminals in a specific user terminal group.

Alternatively, according to another embodiment, the users may not know information about a user terminal group in which their user terminals are included. In this case, the users may not be able to check information about the user terminal group in which their user terminals are included. For example, when a plurality of users share similar interests or exhibit similar usage patterns for an application, in the case of the embodiment, a user terminal group in which each of user terminals of the users satisfying a preset condition is included may be determined by the terminal management apparatus 100.

In operation S130, variable identification values of one or more user terminals included in the first user terminal group may be mapped to the identification value of the first user. The terminal management apparatus 100 may map variable identification values or one or more user terminals included in a single user terminal group to a user identification value and may map user information obtained from the external device to the user identification value. In an embodiment, the user terminal group may include terminals of a plurality of users.

In this case, the terminal management apparatus 100 may map variable identification values of the user terminals included in the user terminal group to identification values of a plurality of users or may generate a user group and map an identification value of the corresponding user group to the variable identification values of the user terminals. In an embodiment, the terminal management apparatus 100 may separately generate an identification value for the user terminal group and map the identification value of the user terminal group to a user identification value and/or an identification value of a user group.

In an embodiment, the user identification value may include unique data for each user. For example, the user identification value may be an ID value determined by the user, may be unique identification data of the user arbitrarily assigned by the terminal management apparatus 100, or may be a user identification value assigned according a preset rule. For example, a user identification value satisfying a preset rule may be generated based on information such as information about an application used by a user, a user's usage pattern for a user terminal, etc.

Thereafter, in operation S140, user information obtained from the external device may be mapped to the identification value of the first user. According to some embodiments of the disclosure, the terminal management apparatus 100 may not obtain personal information about the user as well as a fixed device-specific value of the user terminal to increase security. In the embodiment, the terminal management apparatus 100 may obtain user information from the external device, which is a third party in which user account information is stored, and may identify the user by mapping the user account information obtained from the external device to the user identification value. As the user information is mapped to the user identification value in operation S140, the variable identification value of the user terminal and the user information described above in operation S130 may be mapped to each other. In an embodiment, when each of identification values of the user terminals included in the single user terminal group is mapped to the same user identification value, each of the identification values of the user terminals included in the user terminal group described above may also be mapped to the same user information.

In operation S150, according to an optional embodiment, designated content may be transmitted to one or more user terminals included in the first user terminal group. In an embodiment, after performing operations S110 to S140 described above, the terminal management apparatus 100 may transmit designated content to the one or more user terminals included in the single user terminal group. In an embodiment, the terminal management apparatus 100 may also transmit content received from a separate content providing device to the one or more user terminals. In an embodiment, the content providing device may also directly transmit the content to the one or more user terminals in response to a request of the terminal management apparatus 100.

Also, the content providing device and the terminal management apparatus 100 are not necessarily included in separate hardware, and the content providing device may be a module included in hardware of the terminal management apparatus 100. In this case, the content providing device and the terminal management apparatus 100 may be implemented as software modules which are physically separated from each other.

In an embodiment, the terminal management apparatus 100 may transmit the same content to one or more user terminals included in the same user terminal group. Also, in an embodiment, in this case, the content may be determined based on the user identification value. For example, a first user terminal and a second user terminal mapped to the same user identification value may be included in the same user terminal group. In this regard, the terminal management apparatus 100 may transmit the content to the second user terminal based on information about the first user terminal or may transmit content designated based on information about a first application executed in the first user terminal to a second application executed in the first user terminal.

In an embodiment, the same content may be transmitted to the one or more user terminals included in the same user terminal group. That is, by providing the same content to all user terminal groups generated according to the purpose of a service provider, a plurality of terminals may efficiently be managed. Alternatively, different pieces of content may be transmitted to a plurality of user terminals included in the same user terminal group. In this case, content transmitted to each of the user terminals may be similar content or may be content included in a plurality of content groups grouped according to a preset criterion. For example, when content transmitted to the user terminal group is advertisement content, the same or similar advertisement content may be transmitted to each of user terminals included in a single user terminal group grouped according to a preset criterion.

In an embodiment, the same or similar content may be transmitted to each of user terminals included in different user terminal groups. Hereinafter, a terminal management method when a plurality of user terminal groups respectively mapped to a plurality of different user identification values are generated will be described in detail with reference to FIG. 5. According to some embodiments of the disclosure, it should be noted that the number of users and the number of user terminals used in the terminal management method are not limited thereto.

In operation S160, a variable identification value of a second user terminal of a second user different from the first user may be obtained. Similar to a variable identification value of the first user terminal, the variable identification value of the second user terminal may also be a unique value of the second user terminal that is changeable by the second user. For example, the variable identification value of the second user terminal may include ADID information about the second user terminal.

In operation S170, a second user terminal group including the second user terminal may be generated based on an identification value of a second user. In an embodiment, the second user terminal group may correspond one-to-one to the identification value of the second user. However, as described above, the user terminal groups generated according to some embodiments of the disclosure may include a plurality of user terminals of a plurality of users according to a preset condition.

In operation S180, whether the identification value of the first user and the identification value of the second user satisfy the preset condition may be checked. In the embodiment, the terminal management apparatus 100 may transmit, based on whether the first user and the second user satisfy the preset condition, content designated based on the identification value of the first user to the user terminal of the second user.

The preset condition may be designated by using each user's usage information for a user terminal. For example, the terminal management apparatus 100 may obtain interest information among users based on a user's usage information for a specific application and may obtain usage pattern information for a user terminal based on a user's usage record for a user terminal. In this case, the terminal management apparatus 100 may determine whether the preset condition is satisfied based on whether the interest information is the same or similar among the users and whether usage patterns for the user terminal are the same or similar among users.

In an embodiment, the terminal management apparatus 100 may determine whether the preset condition is satisfied based on user information obtained from a third-party device mapped to a user identification value. For example, the user information obtained by the terminal management apparatus 100 from the third-party device may include relationship information between users (e.g., a friend relationship, a family relationship, a contact sharing relationship, etc.). In this case, the terminal management apparatus 100 may determine that the preset condition is satisfied only when a specific relationship between users is satisfied. The preset condition is an example for facilitating understanding of the disclosure, and preset conditions according to some embodiments of the disclosure are not limited to those described above.

In the embodiment, content transmitted to a user terminal may be, for example, advertisement content. In this case, the terminal management apparatus 100 may designate and transmit advertisement content by using information about a corresponding user terminal and one or more of information about another user terminal, information about a user terminal used in the past, and information about a user terminal of another user.

In an embodiment, the identification value of the first user and the identification value of the second user satisfy the preset condition in operation S180, content determined based on the identification value of the first user may be further transmitted to one or more user terminals included in the second user terminal group in operation S190. That is, the content transmitted to the one or more user terminals included in the second user terminal group may be the same as or similar to the content transmitted to the one or more user terminals included in the first user terminal group.

In an embodiment, when the identification value of the first user and the identification value of the second user do not satisfy the preset condition in operation S180, the series of the terminal management method may be terminated.

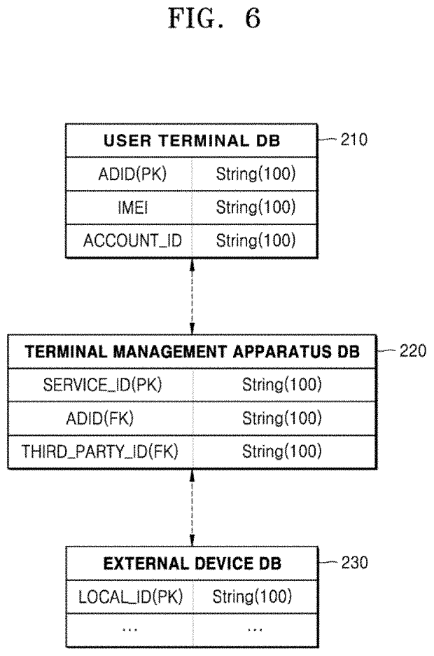

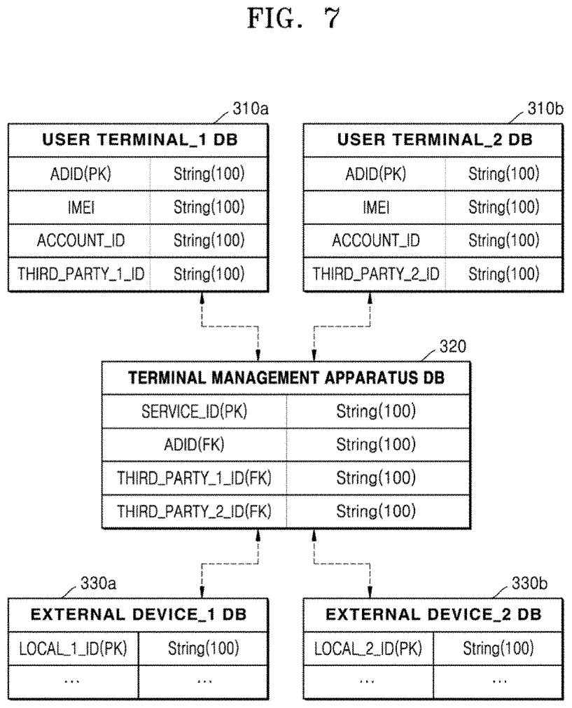

FIGS. 6 and 7 are examples of a database model used in a terminal management method, according to an embodiment of the disclosure. A structure of a database model, a name of a variable, and a type of a variable shown in FIGS. 6 and 7 are only examples for describing embodiments of the disclosure, and the disclosure is not limited thereto.

Hereinafter, a method of mapping a variable identification value of a user terminal, a user identification value, and user information according to an embodiment of the disclosure will be described in detail with reference to FIG. 6.

In an embodiment, in a table 210 stored in a user terminal DB, a variable identification value (ADID) of a user terminal may be designated as a primary key (PK), and in a table stored in a terminal management apparatus DB 220, a user identification value (SERVICE_ID) may be designated as a PK. The embodiment will be described under the assumption that a PK of a table stored in an external device DB 230 is user information (LOCAL_ID). In this case, in the table stored in the terminal management apparatus DB 220, a user identification value (ADID) stored in the table 210 stored in the user terminal DB and user information (LOCAL_ID) stored in the table stored in the external device DB 230 may be respectively designated as ADID and THIRD_PARTY_ID which are foreign keys (FKs), and each table may be referred to by using an FK.

When referring to terminal management apparatus DB 220, the terminal management apparatus may transmit, by referring to a variable identification value (ADID) of a user terminal mapped to the user identification value (SERVICE_ID), content to a user terminal in which the corresponding variable identification value (ADID) includes a database which is a PK. Also, the terminal management apparatus DB 220 may further include information about a PK of an external device (e.g., ‘LOCAL_ID’ in FIG. 6) and may further store an FK that may refer to the PK. For example, as shown in FIG. 6, the terminal management apparatus DB 220 may further store information about THIRD_PARTY_ID, which is an FK, corresponding to LOCAL_ID which is a PK of the external device DB 230. Therefore, the terminal management apparatus may further obtain information about a user and/or a user terminal from the external device and may determine whether a preset condition necessary to generate a user terminal group is satisfied or whether a preset condition for designating a user terminal to transmit designated content is satisfied, by using the information obtained from the external device.

A method of obtaining information about a user and/or a user terminal from a plurality of external devices will be described in detail with reference to FIG. 7.

In an embodiment, DBs of a plurality of user terminals included in a single user terminal group may include user information about different external devices.

In this case, a terminal management apparatus DB 320 may store PKs of a plurality of external devices of the same user as FKs, and all of the PKs of the external devices may be mapped to the same user identification value.

For example, as shown in FIG. 7, when it is assumed that a user terminal 1 and a user terminal 2 are user terminals of the same user, user information (‘THIRD_PARTY_1_ID’) of an external device included in a DB 310a of the user terminal 1 and user information (‘THIRD_PARTY_2_ID’) of an external device included in a DB 310b of the user terminal 2 may respectively correspond to user information stored in different external devices. In this case, all of the user information obtained by the terminal management apparatus from different external devices is information about the same user. Accordingly, according to some embodiments of the disclosure, the terminal management apparatus may map PKs of a plurality of external devices including information about the same user to one user identification value. As an example, the terminal management apparatus DB 320 may correspond ‘LOCAL_1_ID’ which is a PK of a DB 330a of an external device 1 and ‘LOCAL_2_ID’ which is a PK of a DB 330b of an external device 2 to ‘SERVICE_ID’ which is a single user identification value. Therefore, the terminal management apparatus may obtain a large number of users and/or a large amount of user information from various external devices and may determine whether a preset condition necessary to generate a user terminal group is satisfied or whether a preset condition for designating a user terminal to transmit designated content, based on the obtained users and/or user information.

FIG. 8 is a diagram for describing a method of providing designated content to a user terminal included in a user terminal group in a terminal management method, according to an embodiment of the disclosure.

Hereinafter, a terminal management method according to some embodiments of the disclosure will be described with reference to FIG. 8 under the assumption that a first user terminal group 411 is generated based on an identification value of a first user 410 and a second user terminal group 421 is generated based on an identification value of a second user 420. In this case, it is assumed that the first user terminal group 411 includes a user terminal A 412 and a user terminal B 413 and the second user terminal group 421 includes a user terminal a 422, a user terminal b 423, and a user terminal c 424.

In an embodiment, the terminal management apparatus 100 may transmit designated content to each user terminal group. The designated content described above in the embodiment is not necessarily transmitted from the terminal management apparatus 100 to the first user terminal group 411 and the second user terminal group 421 and may also be transmitted through the network 40 from the content providing device 30 in response to a request of the terminal management apparatus 100.

In an embodiment, the terminal management apparatus 100 may transmit the same content to one or more user terminals included in the same user terminal group. For example, the terminal management apparatus 100 may transmit the same content to the user terminal A 412 and the user terminal B 413 included in the first user terminal group 411. Similarly, the terminal management apparatus 100 may transmit the same content to the user terminal a 422, the user terminal b 423, and the user terminal c 424 included in the second user terminal group 421. In this case, the content transmitted to the first user terminal group 411 and the second user terminal group 421 may be determined based on the identification value of the first user 410 and the identification value of the second user 420, respectively. The content determined based on the user identification values may be determined based on, for example, user information corresponding to the user identification values and/or a user's user terminal information corresponding to the user identification value. For example, the content transmitted to the first user terminal group 411 may be determined based on usage information for the user terminal A 412 of the first user 410, and the content transmitted to the second user terminal group 421 may be determined based on specific information about the second user 420. In this case, content transmitted to each of the user terminals may be similar content or may be content included in a plurality of content groups grouped according to a preset criterion. For example, when content transmitted to each of the user terminal groups is advertisement content, the same or similar advertisement content may be transmitted to each of user terminals included in a single user terminal group grouped according to a preset criterion.

In an embodiment, when the first user 410 and the second user 420 satisfy a preset condition, the terminal management apparatus 100 may transmit content determined based on the identification value of the first user 410 to the second user terminal group 421. Similarly, the terminal management apparatus 100 may also transmit content determined based on the identification value of the second user 420 to the first user terminal group 411. The preset condition may be designated by using each user's usage information for a user terminal. FIG. 8 illustrates a case where when the first user 410 and the second user 420 satisfy the preset condition, content determined based on usage information for the user terminal A 412 of the first user is transmitted to the first user terminal group 411 and the second user terminal group 421. For example, the terminal management apparatus 100 may obtain interest information among users based on a user's usage information for a specific application and may obtain usage pattern information fora user terminal based on a user's usage record fora user terminal. In this case, the terminal management apparatus 100 may determine whether the preset condition is satisfied based on whether the interest information is the same or similar among the users and whether usage patterns for the user terminal are the same or similar among the users. In an embodiment, the terminal management apparatus 100 may determine whether the preset condition is satisfied based on user information obtained from an external device (e.g., a third-party device) mapped to a user identification value. For example, the user information obtained by the terminal management apparatus 100 from the external device may include relationship information between users (e.g., a friend relationship, a family relationship, a contact sharing relationship, etc.). In this case, the terminal management apparatus 100 may determine that the preset condition is satisfied only when the relationship information between users indicates a specific relationship. The preset condition is an example for facilitating understanding of the disclosure, and preset conditions according to some embodiments of the disclosure are not limited to those described above.

The apparatus described above may be implemented as a hardware component, a software component, and/or a combination of a hardware component and a software component. For example, the apparatus and components described in the embodiments may be implemented by using one or more general-purpose computers or special-purpose computers, such as a processor, a controller, an arithmetic logic unit (ALU), a digital signal processor, a microcomputer, a field programmable gate array (FPGA), a programmable logic unit (PLU), a microprocessor, or any other device capable of executing and responding to instructions. A processing device may execute an operating system (OS) and one or more software applications executed on the OS. Also, the processing device may also access, store, manipulate, process, and generate data in response to the execution of software. For convenience of understanding, it has been described that one processing device is used, but those of ordinary skill in the art will appreciate that the processing device may include a plurality of processing elements and/or a plurality of types of processing elements. For example, the processing device may include a plurality of processors or one processor, and one controller. Also, other processing configurations such as a parallel processor may also be implemented.

Software may include computer programs, codes, instructions, or combinations of one or more of these, and may configure the processing device to operate as desired or instruct the processing device independently or collectively. Software and/or data may be permanently or temporarily embodied in any type of machine, component, physical equipment, virtual equipment, computer storage medium or device, or signal wave being transmitted, in order to be interpreted by the processing device or to provide instructions or data to the processing device. Software may be distributed over networked computer systems and stored or executed in a distributed manner. Software and data may be stored in one or more computer-readable recording media.

The method according to the embodiments of the disclosure may be implemented in program instructions which are executable by various computing means and recorded in computer-readable media. The computer-readable recording media may include program instructions, data files, data structures, and the like solely or in a combined manner. The program instructions recorded on the computer-readable media may be designed and configured specially for the embodiments of the disclosure, or may be well-known to those of ordinary skill in the art of computer software. Examples of the computer-readable recording media may include magnetic media such as hard disk, floppy disk, and magnetic tape, optical media such as compact disk read only memory (CD-ROM) and digital versatile disk (DVD), magneto-optical media such as floptical disk, and hardware devices specially configured to store and execute program instructions, such as read only memory (ROM), random access memory (RAM) and flash memory, etc. Further, examples of the program instructions include a machine language code created by a complier and a high-level language code executable by a computer using an interpreter. The hardware devices may be configured to operate as one or more software modules to perform the operations of the embodiments of the disclosure, and vice versa.

As described above, the embodiments of the disclosure have been described by the limiting embodiments and drawings, but various modifications and variations may be made from the above descriptions by those of ordinary skill in the art. For example, even though the described techniques are performed in orders different from those described above, and/or the described components such as systems, structures, devices, circuits, etc. are coupled or combined in forms different from those described above, or are replaced or substituted by other components or equivalents, appropriate results may be achieved.

Therefore, other implementations, other embodiments, and those equivalent to the appended claims also fall within the scope of the claims to be described below.

What is claimed is:

1. A method, performed by a computing apparatus, of managing a terminal, the method comprising:
obtaining a variable identification value of a first user terminal;
generating a first user terminal group comprising the first user terminal based on an identification value of a first user; and
mapping variable identification values of one or more user terminals comprised in the first user terminal group to the identification value of the first user and mapping user information obtained from an external device to the identification value of the first user.

2. The method of claim 1, further comprising
transmitting designated content to the one or more user terminals comprised in the first user terminal group,
wherein the designated content is determined based on the identification value of the first user.

3. The method of claim 2, further comprising:
obtaining a variable identification value of a second user terminal;
generating a second user terminal group comprising the second user terminal based on an identification value of a second user; and
when the identification value of the first user and the identification value of the second user satisfy a preset condition, transmitting content determined based on the identification value of the first user to one or more user terminals comprised in the second user terminal group.

4. The method of claim 2, wherein
the variable identification value of the first user terminal is a unique value of the first user terminal that is changeable by a user,
log data of a first application executed in the first user terminal corresponds to the variable identification value of the first user terminal, and
the designated content is executed in at least one of the first application and a second application of the first user terminal.

5. The method of claim 2, wherein
the first user terminal group further comprises a third user terminal, and
the designated content transmitted to the third user terminal is determined based on log data of a first application executed in the first user terminal.

6. An apparatus for managing a terminal, the apparatus comprising
a processor,
wherein the processor is configured to obtain a variable identification value of a first user terminal, generate a first user terminal group comprising the first user terminal based on an identification value of a first user, map variable identification values of one or more user terminals comprised in the first user terminal group to the identification value of the first user, map user account information obtained from an external device to the identification value of the first user, and transmit designated content to the one or more user terminals comprised in the first user terminal group, wherein the designated content is determined based on the identification value of the first user.
